(19) United States
(12) Patent Application Publication
(10) Pub. No.: US 2025/0384375 A1
(43) Pub. Date: Dec. 18, 2025

(54) CORRELATING TELEMATICS AND VEHICLE DATA WITH ASYNCHRONOUS DATA LOG ENTRIES

(71) Applicant: MOTIVE TECHNOLOGIES, INC., San Francisco, CA (US)

(72) Inventors: Prahadeesh GIRIDHARAN, Chennai (IN); Yuhuan TANG, Oakland, CA (US); Dhruvi Vora SINGH, Indore (IN)

(21) Appl. No.: 18/796,587

(22) Filed: Aug. 7, 2024

Related U.S. Application Data
(60) Provisional application No. 63/661,121, filed on Jun. 18, 2024.

(51) Int. Cl. G06Q 10/0637

(52) U.S. Cl. CPC G06Q 10/0637; G06F 2212/173; G08G 1/20

(57) ABSTRACT

In some implementations, the techniques described herein relate to a method including: receiving a data log entry associated with a driver that includes a service provider location and a timestamp; identifying a vehicle associated with the driver based on the data log entry by identifying the vehicle includes applying a machine learning model to the data log entry and a vehicle database; loading a vehicle location log associated with the identified vehicle, the vehicle location log including a plurality of location data points and associated timestamps; computing an alternate data log entry based on the data log entry and the vehicle location log, wherein computing the alternate data log entry includes applying a rule-based optimization algorithm to a historical service provider database; and transmitting a recommendation based on the alternate data log entry, wherein the recommendation includes a geospatial visualization of the alternate data log entry.

### CROSS-REFERENCE TO RELATED APPLICATIONS

This application claims the benefit of priority of Provisional Pat. Appln. No. 63/661,121 filed on Jun. 18, 2024, which is hereby incorporated by reference in its entirety.

### BACKGROUND

Fleet management is a critical function for organizations that rely on transportation and logistics to carry out their operations. Effective fleet management involves a wide range of activities, from vehicle maintenance and driver scheduling to fuel optimization and safety compliance. In recent years, advances in data analytics, machine learning, and mobile computing have opened up new opportunities for fleet managers to optimize their operations and improve their bottom line.

### BRIEF DESCRIPTION OF THE FIGURES

FIG. 1 is a block diagram illustrating a system for optimizing vehicle fleet operations by analyzing and integrating data from multiple sources.

FIG. 2 illustrates a flow diagram of a method for identifying potential optimization opportunities for a vehicle based on a single transaction.

FIG. 3 illustrates a flow diagram of a method for matching a transaction to a specific vehicle in a fleet management system.

FIG. 4 illustrates a flow diagram of a method for generating a fleet dashboard that provides an aggregated view of optimization opportunities across multiple transactions and vehicles.

FIG. 5 illustrates a flow diagram of a method for generating and visualizing alternative routes based on the optimized transactions identified in the previous steps.

FIG. 6 illustrates a flow diagram of a method for providing real-time fuel optimization recommendations to drivers based on their current fuel level and location.

FIG. 7 illustrates a flow diagram of a method for generating and delivering real-time driver feedback and coaching based on their fuel optimization performance.

FIG. 8 is a UI diagram illustrating a savings by cardholder dashboard and selected cardholder according to some of the disclosed embodiments.

FIG. 9 is a UI diagram illustrating a selected driver and expanded service provider alternative according to some of the disclosed embodiments.

FIG. 10 is a UI diagram illustrating a savings by service provider dashboard and selected service provider according to some of the disclosed embodiments.

FIG. 11 is a UI diagram illustrating an individual transaction and alternative transaction according to some of the disclosed embodiments.

FIG. 12 is a block diagram of a computing device according to some embodiments of the disclosure.

### DETAILED DESCRIPTION

One key area of focus for fleet optimization is fuel management. Fuel costs are often one of the largest expenses for fleet operators, and even small improvements in fuel efficiency can translate into significant cost savings over time. Traditional fuel management strategies, such as driver training and route optimization, have been used for decades to help fleet managers reduce their fuel costs. However, these strategies often rely on manual processes and historical data analysis, which can be time-consuming, labor-intensive, and prone to errors.

Another important aspect of fleet management is driver coaching and performance management. Drivers play a critical role in the success of any fleet operation, and their behavior and decision-making can have a significant impact on fuel efficiency, safety, and customer satisfaction. Traditional driver coaching methods, such as classroom training and ride-alongs, can be effective at improving driver performance, but they are often difficult to scale and personalize to the needs of individual drivers.

To address these challenges, there is a growing need for more advanced and automated fleet optimization and driver coaching solutions that can leverage the power of real-time data, analytics, and mobile technology. Such solutions can help fleet managers to monitor and optimize their operations in real-time, while also providing drivers with personalized and actionable feedback that can help them to improve their performance and decision-making on the job.

However, developing and deploying such solutions can be a complex and challenging undertaking, requiring expertise in a wide range of disciplines, from data science and machine learning to mobile app development and user experience design. Fleet managers and solution providers must also navigate a complex landscape of technical, operational, and regulatory challenges, from data privacy and security to driver acceptance and adoption.

Accordingly, there is a need for a comprehensive and integrated system and method for real-time fleet optimization and driver coaching that can address these challenges and provide fleet managers and drivers with the tools and insights they need to optimize their operations and improve their performance. Such a system and method should be able to collect, process, and analyze large volumes of real-time data from multiple sources, including vehicles, drivers, and external systems, and use advanced analytics and machine learning techniques to generate actionable insights and recommendations. It should also be able to deliver these insights and recommendations to drivers and fleet managers in a timely, personalized, and user-friendly way, using a range of communication channels and user interfaces. Finally, it should be scalable, secure, and flexible enough to adapt to the changing needs and requirements of different fleet operators and environments. The disclosed embodiments, solve these and other problems as described herein.

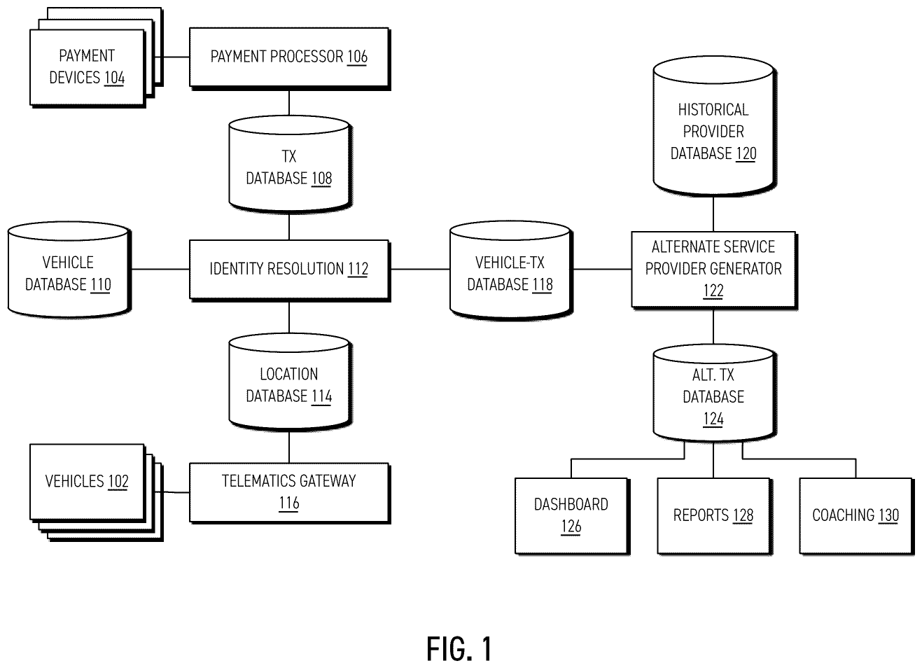

FIG. 1 is a block diagram illustrating a system for optimizing vehicle fleet operations by analyzing and integrating data from multiple sources.

The system includes payment devices 104, a payment processor 106, and a transaction database 108. Payment devices 104 can include various devices for drivers to initiate transactions, such as fuel cards, credit cards, or mobile payment apps. When a driver makes a purchase, payment information is sent to the payment processor 106, which handles the transaction and records the details in the transaction database 108. The transaction database 108 stores information such as the transaction amount, the service provider location, the time and date, and any associated metadata. The specific details of processing transactions are not described in detail herein for the sake of clarity. Indeed, any payment processing technique may be used in combination with the disclosed embodiments and the disclosed embodiments do not include a specific payment processing technique. In some implementations, the method can obtain the service provider location from a third-party database of service providers which tracks geographic locations of such service providers. Alternatively, or in conjunction with the foregoing, the method can refine or detect the locations of service providers based on telematics data recorded by a fleet of drivers. For example, the method can correlate service provider transactions with independent GPS recordings to triangulate a location for a service provider. This GPS-inferred location can then be used to either (a) refine a pre-stored location for a given service provider; or (b) generate a true location for the service provider. As illustrated, in some implementations, multiple such recordings can be taken, and a geographic mean can be used as the estimated location of the service provider. In some implementations, this mean can further be compared to block/lot identifiers or other street address representations to further refine the geographic position of a service provider.

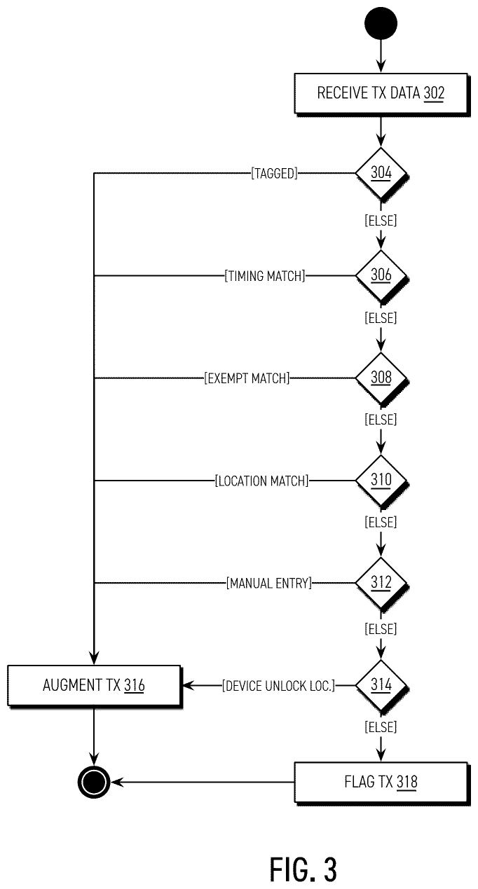

The system is responsible for associating each transaction with a specific vehicle in the fleet. Generally, transactions are not tied to vehicles or drivers. Thus, in a conventional system there is no technical way to automatically associate a given payment transaction with a specific driver or vehicle. Instead, many systems rely pre-programmed, associations or manual input. To solve this problem, system includes an identity resolution component 112, which takes input from the transaction database 108 and the vehicle database 110. The vehicle database 110 contains information about each vehicle in the fleet, such as its make, model, license plate number, and assigned driver. The identity resolution component 112 uses advanced algorithms, such as machine learning models or rule-based systems, to match transactions to vehicles based on factors like the payment method used, the location and time of the transaction, and any driver input provided during the transaction process. These algorithms can be continuously refined using techniques like reinforcement learning to improve the accuracy of the matching process over time. Once a match is made, the transaction is recorded in the vehicle-transaction database 118, which maintains a complete history of each vehicle's transactions. Details of this process are described more fully in the description of FIG. 3.

Alternatively, or in conjunction with the foregoing, identity resolution component 112 can associate transactions with specific vehicles using techniques such as using multi-modal deep learning models that combine visual features from vehicle images with textual features from transaction records. In some implementations, these models are trained using a contrastive learning approach that learns to embed vehicles and transactions into a shared latent space, enabling efficient and accurate matching even in the presence of noisy or incomplete data. The identity resolution component also employs advanced data structures and indexing techniques, such as locality-sensitive hashing and hierarchical clustering, to enable real-time matching and retrieval of vehicle information from large-scale databases. Identity resolution component 112 can employ advanced machine learning algorithms, such as deep learning models like convolutional neural networks (CNNs) and recurrent neural networks (RNNs), to extract relevant features from the transaction and vehicle data and learn complex patterns over time. These models can be trained on large datasets of historical transactions and vehicle information, using techniques like transfer learning and data augmentation to improve accuracy and generalization. The identity resolution component also utilizes probabilistic data matching techniques, such as fuzzy matching and probabilistic record linkage, to handle noisy or incomplete data and provide confidence scores for each match.

A telematics processing subsystem collects real-time data from vehicles 102 equipped with telematics devices. These devices can include GPS receivers, accelerometers, and onboard diagnostic (OBD) systems that transmit information such as the vehicle's location, speed, fuel tank level, fuel consumption, and engine performance to the telematics gateway 116. In some implementations, vehicles 102 can be equipped with a dashcam and optional gateway device to captures and transmit telematics data. In some implementations, the telematics gateway 116 is responsible for ingesting and processing the raw telematics data, which can involve applying data cleaning, normalization, and compression techniques to ensure data quality and minimize storage requirements. It can also receive driver input through mobile apps or in-vehicle displays, such as confirming the vehicle's current driver or entering a vehicle ID at the pump. The processed telematics data is stored in the location database 114, which maintains a history of each vehicle's movements and performance over time.

The telematics gateway 116 is responsible for ingesting and processing high-volume, high-velocity data streams from vehicle telematics devices. In some implementations, telematics gateway 116 can utilize an adaptive data ingestion framework that dynamically adjusts its data processing pipelines based on the characteristics of the incoming data streams. This framework can utilize techniques such as query optimization, load shedding, and elastic resource provisioning, to ensure low-latency, high-throughput processing even under variable and bursty workloads. The telematics gateway 116 can also incorporate data compression and encoding techniques, such as learned compression models and adaptive quantization, to minimize data transfer costs and storage requirements while preserving the quality and fidelity of the telematics data. In some implementations, telematics gateway 116 can utilize big data technologies like Apache Kafka® and Apache Flink® to enable real-time stream processing and analytics. Kafka® can act as a distributed messaging system, allowing the gateway to ingest and buffer incoming data streams from thousands of vehicles simultaneously. Flink® can provide a stream processing engine that can apply complex transformations, aggregations, and machine learning models to the data in real-time, enabling low-latency insights and decision-making. The telematics gateway 116 can also utilize data compression and encoding techniques, such as Protocol Buffers and Avro, to minimize data transfer costs and storage requirements.

Alternative service provider generator 122 can analyze the matched transaction and telematics data to identify optimization opportunities. Alternative service provider generator 122 can take input from the vehicle-transaction database 118 and a historical provider database 120, which contains current and historical data on service providers across the country. Alternative service provider generator 122 can utilize algorithms, such as graph traversal, shortest path finding, and clustering, to identify potential optimizations based on factors like geographic proximity, time of day, and historical trends. These algorithms can leverage techniques from fields like operations research and network science to find optimal solutions in large, complex datasets. The identified optimizations are stored in the alternate data log entry database 124 for further analysis and visualization. In some implementations, the alternative service provider generator 122 can identify savings opportunities not only in the proximity of a refill transaction but also along a route, possibly using the vehicle's tank level information. It can also identify savings at the beginning or end of a day or shift, providing a more comprehensive view of potential cost-saving opportunities.

In some implementations, alternative service provider generator 122 can use optimization algorithms and techniques to identify the most promising opportunities for fleet optimization. In some implementations, alternative service provider generator 122 can employ a hierarchical optimization framework that decomposes the complex optimization problem into multiple subproblems, each focusing on a specific aspect of the fleet operations (e.g., routing, scheduling, resource allocation). These subproblems are solved using specialized algorithms and techniques, such as graph neural networks for route optimization, reinforcement learning for adaptive scheduling, and multi-objective evolutionary algorithms for resource allocation. The results of these subproblems are then combined and coordinated using a high-level optimization model, which ensures the overall consistency and optimality of the generated recommendations. This hierarchical approach enables the system to find high-quality solutions to large-scale, complex optimization problems that are intractable using conventional methods. It formulates the problem of finding optimal alternative service providers as a constrained optimization problem, taking into account various factors such as cost, distance, time, and capacity constraints. To solve this problem efficiently, the generator employs algorithms from the field of operations research, such as linear programming, mixed-integer programming, and metaheuristics like genetic algorithms and simulated annealing. These algorithms can find near-optimal solutions in large, complex search spaces by intelligently exploring and exploiting promising regions of the solution landscape. The generator also incorporates machine learning models, such as reinforcement learning agents, that can learn from past optimization outcomes and adapt to changing conditions over time. The optimization algorithm can also incorporate fleet-specific and customized discounts, such as pricing, rebates, discounts, and partner service provider offers, to maximize the savings calculation for each fleet. In some implementations, prices associated with service providers can be obtained directly from partner service providers. Alternatively, or in conjunction with the foregoing, prices associated with service providers can be obtained from third-party databases that track prices for service providers. Alternatively, or in conjunction with the foregoing, the method can infer prices for service providers based on historical transactions with the service providers.

The insights generated by the alternative service provider generator 122 are surfaced to fleet managers through the dashboard 126, reports 128, and coaching 130 components. The dashboard 126 can provide a real-time or historical overview of the fleet's performance, highlighting key metrics and trends using interactive visualizations. Fleet managers can drill down into specific transactions or vehicles to see more detailed information, such as route maps and performance charts. The various output components (e.g., dashboard 126, reports 128, and coaching 130 components) are not intended to be limiting and other output components may be added. For example, the system may include a real-time cardholder push notification suggestion service that can monitor locations of vehicles and detect when those vehicles are nearby service providers. In some implementations, this real-time cardholder push notification suggestion service can then determine if the nearest service provider is an expensive service provider. If so, the real-time cardholder push notification suggestion service can identify an alternative service provider (using the methods described herein) and push a notification to a driver (or other entity) providing information associated with the alternative service provider (as discussed herein).

The reports 128 component generates periodic summaries of the fleet's performance and optimization opportunities, such as weekly or monthly email digests. These reports can include advanced visualizations such as heat maps, scatter plots, and network graphs to help fleet managers quickly identify patterns and anomalies. They may also include machine learning-powered forecasts and recommendations, such as predicting future service needs based on historical data and weather patterns. In some implementations, reports 128 may be pushed to fleet managers via, for example, email messages or other forms.

The dashboard 126 and reports 128 components of the system employ advanced data visualization and visual analytics techniques to help fleet managers make sense of complex optimization data and insights. In some implementations, they can utilize web technologies and frameworks to create interactive, dynamic visualizations that allow users to explore and drill down into the data at multiple levels of granularity. These visualizations can range from simple charts and graphs to more advanced techniques like parallel coordinates plots, t-SNE maps, and network visualizations, depending on the specific data and use case. The dashboard and reports also incorporate principles from the field of visual perception and cognition, such as the use of color, shape, and spatial encoding to convey meaning and guide attention. They may also employ machine learning-powered recommendation systems to suggest relevant visualizations or insights based on user behavior and preferences.

The coaching 130 component provides personalized recommendations and feedback to individual drivers based on their behavior and performance. It can use techniques from behavioral psychology and gamification to nudge drivers towards optimal decisions, such as suggesting alternative service providers or providing incentives for eco-friendly driving habits. The coaching component can deliver this feedback through a variety of channels, such as mobile app notifications, in-vehicle displays, or even virtual assistants powered by natural language processing. In some implementations, the coaching 130 component can additionally allow a fleet manager to transmit messages using pre-defined templates.

Finally, the coaching 130 component of the system can use advanced natural language processing (NLP) and generation (NLG) techniques to provide personalized, contextually relevant feedback and recommendations to drivers. In some implementations, coaching 130 component can utilize deep learning models like transformers and sequence-to-sequence models to understand driver behavior and preferences from unstructured data sources like text messages, voice commands, and feedback forms. In some implementations, coaching 130 component can then generate human-like responses and recommendations using techniques like template-based generation, retrieval-based generation, and reinforcement learning-based dialogue systems. These techniques allow the system to adapt its communication style and content to the individual driver, providing a more engaging and effective coaching experience. The coaching component may also incorporate affective computing techniques to detect and respond to driver emotions and stress levels, helping to promote safer and more satisfying driving experiences.

In some implementations, the system can also incorporate advanced security and privacy features to protect sensitive data. For example, the payment processor 106 can use encryption and tokenization techniques to secure financial information, while the identity resolution component 112 can use anonymization and differential privacy methods to protect driver privacy. The system can also implement role-based access control and audit logging to ensure that only authorized users can access and manipulate data.

In addition to the core subsystems and components, the system can be extended with various plugins and integrations to support additional use cases and data sources. For example, it could integrate with weather data APIs to factor in environmental conditions when generating alternative service provider recommendations, or with traffic data feeds to optimize route planning and scheduling. It could also integrate with third-party fleet management software to enable data sharing and workflow automation. The system can also accommodate different types of customers, including both card and non-card users. For non-card customers, the system can leverage the vehicle location history to identify potential savings opportunities. Furthermore, the system can handle various fuel types, such as diesel, gasoline, hydrogen refills, and electric vehicle charging, ensuring its applicability across a wide range of vehicle fleets. To enable the connections between entities, the system can employ various mapping techniques. These include driver/vehicle mapping, card/vehicle mapping, and vehicle location and discount search. These mappings serve as foundational information for the overall functionality of the system and can potentially be utilized in other patent applications as well.

To implement the system illustrated in FIG. 1, a modern, scalable architecture based on microservices and event-driven design patterns could be employed. The system could be decomposed into a set of loosely coupled, independently deployable services, each responsible for a specific functional area or data domain. For example, separate services could be created for transaction processing, vehicle matching, telematics data ingestion, and optimization. These services could communicate with each other through lightweight, asynchronous messaging protocols, allowing for high throughput and fault tolerance. The services could be implemented using polyglot programming languages and frameworks depending on the specific requirements and team expertise. Each service could be packaged as a Docker® container and deployed on a managed Kubernetes® cluster, enabling easy scaling and resilience. The data storage layer could be implemented using a combination of SQL and NoSQL databases, such as PostgreSQL® for structured data and Apache Cassandra® for high-volume time-series data, with an event sourcing pattern to ensure data consistency and auditability. The user-facing components, such as the dashboard and coaching interfaces, could be implemented as single-page applications using modern web frameworks, with server-side rendering for optimal performance and SEO. The entire system could be deployed on a public or private cloud platform, such as Amazon AWS®, with a focus on security, compliance, and cost optimization through the use of serverless computing, auto-scaling, and infrastructure as code (IaC) practices.

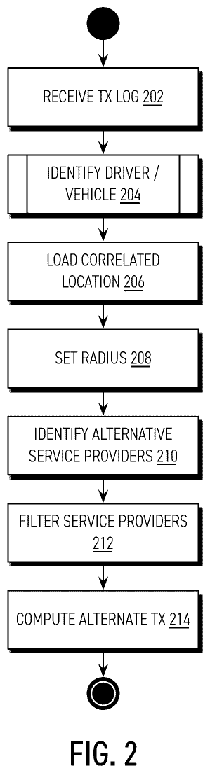

FIG. 2 illustrates a flow diagram of a method for identifying potential optimization opportunities for a vehicle based on a single transaction.

In step 202, the method can include receiving a data log entry. In some implementations, this log can include detailed information about a specific transaction event, such as the timestamp, location, service type, and any associated metadata. The data log entry serves as the primary input for the subsequent optimization process. In some implementations, the data log entry can include a dollar amount spent. For example, the data log entry may comprise a purchase at a gas station or service center.

Upon receiving the data log entry, the method proceeds to step 204, where it identifies the driver and vehicle associated with the transaction. In some implementations, the driver and vehicle identification process can comprise the process described in FIG. 3. For example, in brief, the method may employ fuzzy matching algorithms to handle variations in driver names or vehicle identifiers, or use machine learning models to predict driver and vehicle associations based on patterns in the transaction data. The method may also incorporate external data sources, such as driver schedules or vehicle maintenance records, to improve the accuracy and reliability of the identification process.

Once the driver and vehicle have been identified, the method moves to step 206, where it loads correlated location data. This step involves retrieving relevant spatial and temporal data associated with the transaction and vehicle, such as the geographic coordinates of the service location, the time and day of the week, and any available information about the surrounding area (e.g., road networks, traffic patterns). In some implementations, the location data can also include historical locations (e.g., GPS coordinates) of the identified vehicle/driver. The correlated location data is essential for understanding the context in which the transaction occurred and identifying potential alternatives. To efficiently handle large volumes of location data, the method may employ advanced indexing and querying techniques, such as spatial partitioning or hierarchical data structures. These techniques enable fast retrieval and processing of location-based queries, even for transactions occurring in dense urban areas or along complex road networks.

With the correlated location data loaded, the method proceeds to step 208, where it sets a search radius for identifying alternative service providers. The search radius determines the geographic area within which the method will look for potential optimization opportunities. Setting an appropriate search radius is useful for balancing the trade-off between the potential for optimization and the practical constraints of time, distance, and convenience. The method may use a variety of techniques to determine the optimal search radius, such as analyzing historical transaction patterns, considering the vehicle's fuel level and range, or incorporating real-time traffic and weather conditions. In some cases, the method may dynamically adjust the search radius based on the specific characteristics of the transaction or the preferences of the fleet manager.

In step 210, the method can include identifying alternative service providers within the previously set search radius. This step involves querying a comprehensive database of service providers, which may include fuel stations, maintenance facilities, rest stops, and other relevant points of interest. The database is regularly updated with the latest information about service providers, including their locations, hours of operation, available services, and pricing. To efficiently search this database and identify relevant alternatives, the method can use querying and ranking techniques. For example, it may use spatial indexing structures, such as R-trees or quadtrees, to quickly find service providers within the specified search radius. It may also employ machine learning algorithms, such as collaborative filtering or gradient boosting, to rank the service providers based on their relevance and potential for optimization. In some implementations, step 210 can further analyze the actual road distance between the service provider in the transaction and the alternative service providers. If implemented, this approach discards suggestions that have a large road or travel distance but smaller absolute (e.g., bird's flight) direction, thus considering the realities of travel between service providers.

After identifying a set of alternative service providers, the method moves to step 212, where it filters the results based on predefined criteria. These criteria may include factors such as the service type (e.g., fuel, maintenance), the vehicle's compatibility with the service provider (e.g., fuel type, size restrictions), or the driver's preferences (e.g., brand loyalty, amenities). In some implementations, the method can further utilize a driver's acceptance or rejection of alternative service providers to refine future suggestions. For example, a preference model can be built to filter alternative service providers based on past driver interactions with suggestions. Filtering the alternative service providers helps to narrow down the options to the most relevant and feasible alternatives, reducing unnecessary computations and improving the quality of the optimization results. In some implementations, the filtering process may involve a combination of rule-based and machine learning approaches. For example, the method may use a decision tree or a set of expert-defined heuristics to quickly eliminate unsuitable alternatives, and then apply more sophisticated machine learning models, such as neural networks or support vector machines, to refine the remaining options based on more nuanced criteria.

Finally, at step 214, the method can compute an alternate data log entry based on the filtered alternative service providers. This step involves simulating the potential outcomes of selecting each alternative and comparing them to the original transaction. In some implementations, the method may consider various factors when computing the alternate data log entry, such as the estimated fuel consumption, the expected time of arrival, or the total cost of the service. To accurately model these factors, the method may employ advanced techniques from the fields of physics, operations research, and econometrics. For example, the method may use fluid dynamics equations to estimate fuel consumption based on the vehicle's specifications and the road conditions, or apply queueing theory to predict wait times at service providers based on historical data and real-time traffic information. The method may also incorporate machine learning models, such as deep neural networks or reinforcement learning agents, to continuously improve its predictions and adapt to changing conditions.

At this point, the method has successfully identified a potential optimization opportunity for the given transaction, taking into account the specific driver, vehicle, location, and service context. This information can be used to generate actionable insights and recommendations for the fleet manager, such as suggesting an alternative route, recommending a different service provider, or adjusting the vehicle's maintenance schedule. Various use cases are described more fully herein.

In terms of the user interface, the method may provide a range of visualizations and interactive tools to help fleet managers and drivers understand and act upon the optimization results. For example, it may generate a map view that shows the original transaction location, the alternative service providers, and the potential routes between them. It may also provide a chart view that compares the estimated costs, time, and other metrics for each alternative, allowing users to easily assess the trade-offs and make informed decisions.

Overall, the method described in FIG. 2 represents a significant technical advancement in the field of fleet optimization and management. By leveraging state-of-the-art techniques from data science, machine learning, and operations research, the method is able to identify potential optimization opportunities with unprecedented accuracy and efficiency. This not only helps fleet managers to reduce costs and improve performance, but also contributes to broader goals, such as reducing traffic congestion and environmental pollution.

Moreover, the method demonstrates a deep integration of various technical disciplines and a holistic approach to problem-solving. Rather than focusing on a single aspect of the optimization process, such as route planning or fuel consumption modeling, the method considers the full context of each transaction, from the driver and vehicle characteristics to the spatial and temporal constraints. This approach enables a more comprehensive and nuanced optimization that takes into account the complex interdependencies and trade-offs involved in real-world fleet operations.

In conclusion, FIG. 2 presents a method for optimizing vehicle fleets based on individual transactions. By combining advanced techniques from data science, machine learning, and operations research, the method is able to identify potential optimization opportunities with unparalleled accuracy and efficiency, while also considering the full context and complexity of each transaction. This represents a significant technical advancement that has the potential to transform the way fleets are managed and optimized, leading to significant benefits for businesses, society, and the environment.

FIG. 3 illustrates a flow diagram of a method for matching a transaction to a specific vehicle in a fleet management system.

The following method addresses the challenge of associating an individual driver's credit card transaction with a correct vehicle of a fleet, which is enables providing accurate and actionable insights to fleet managers.

In step 302, the method can include receiving transaction data. This data includes details such as the timestamp, location, amount, and driver identifier associated with the transaction. However, it does not explicitly specify the driver or vehicle for which the transaction was made. In the context of fleet management, a single driver may operate multiple vehicles at different times, making it necessary to determine which vehicle was involved in each transaction.

After receiving the transaction data, the method proceeds to a series of decision points that apply various matching techniques in a hierarchical manner. Each technique leverages different pieces of information and logic to infer the correct vehicle association.

The first decision point at step 304 checks if the transaction has already been tagged with a vehicle association. This tagging could have been done manually by a fleet manager through a web dashboard or by a driver via a mobile application. If the transaction is already tagged, the method skips the remaining decision points and proceeds directly to step 316, where the transaction is augmented with the known vehicle information.

If the transaction is not already tagged, the method moves to the next decision point at step 306, which attempts to match the transaction based on timing information. In commercial trucking, drivers often are required to pair their devices with the Electronic Logging devices (ELDs) on the vehicle and “driving periods” are inferred where the driver was driving a specific vehicle. By comparing the transaction timestamp with these known driving periods, the method can infer the most likely vehicle association. If a timing match is found, the method proceeds to step 316 to augment the transaction with the inferred vehicle information.

If no timing match is found, the method proceeds to step 308, which checks for an exempt driver match. In commercial trucking, some drivers are designated as “exempt” from certain regulations, such as limits on driving hours. These exempt drivers may be assigned to a specific vehicle for an extended period, regardless of the normal driving periods. If the transaction is associated with an exempt driver, the method can infer the vehicle based on this long-term assignment and proceed to step 316.

In some implementations, additional checks may be employed. For example, if a vehicle has a inward-facing camera attached, the method may detect the identity of the driver driving the vehicle using face ID or similar technology. Then, the method may map a driver's face ID to a driver ID using a pre-stored mapping. In other implementations, if a vehicle in the fleet had a corresponding fuel tank level increase as per the purchased fuel, the method can automatically link the transaction to this vehicle.

If the transaction does not involve an exempt driver, the method moves to step 310, which attempts to match the transaction based on location data. In some implementations, the method can track the real-time location of vehicles using GPS or other telematics devices. By comparing the transaction location with the known vehicle locations at the time of the transaction, the method can infer the most likely vehicle association. If a location match is found, the transaction is augmented with the inferred vehicle information at step 316.

If no location match is found, the method proceeds to step 312, which checks if the vehicle was manually entered by the driver at the time of the transaction. In some implementations, the method may allow drivers to manually input the vehicle ID through a mobile app or other interface before making a transaction. In some implementations, step 312 may be performed immediately after step 302 and before step 304. If such manual input is detected, the method can directly assign the transaction to the specified vehicle and proceed to step 316.

If the vehicle was not manually entered, the method moves to the final decision point at step 314, which checks if the vehicle can be inferred based on a device unlock event. In some cases, drivers may use a mobile app or other device to “unlock” a specific vehicle before starting their shift. By analyzing the location of the unlock event and comparing it with the transaction location, the method can infer the vehicle association. If a device unlock match is found, the transaction is augmented with the inferred vehicle information at step 316. In some implementations, after step 302, the method may perform step 312 and step 314 prior to step 304.

If none of the above matching techniques succeed, the method proceeds to step 318, where the transaction is flagged for manual review. This flagging allows fleet managers to intervene and manually assign the transaction to the correct vehicle based on their domain knowledge and additional context.

Finally, the method ends after either augmenting the transaction with the inferred vehicle information or flagging it for manual review. In some implementations, the foregoing decision points can be cumulative rather than exclusive. That is, instead of branching immediately to step 316, each decision point can “strengthen” the guess of a vehicle by increasing the confidence that a given vehicle should be associated with a given transaction. These changes can be both additive (a reinforcing decision point) or subtractive (a conflicting decision point).

The hierarchical matching approach illustrated in FIG. 3 provides a robust and efficient way to associate transactions with vehicles in a fleet management system. By applying multiple matching techniques, the method can accurately infer vehicle associations in a variety of scenarios, reducing the need for manual intervention and improving the overall quality of the data.

One technical aspect of this method is its use of real-time location data from GPS and other telematics devices. By continuously tracking the location of vehicles in the fleet, the method can create a rich spatial-temporal dataset that enables advanced analytics and optimization. For example, by analyzing the historical location data of vehicles and comparing it with the location of transactions, the method can identify patterns and anomalies that may indicate potential issues or opportunities for improvement.

In some implementations, the method can further use machine learning and artificial intelligence techniques to improve the accuracy and efficiency of the matching process. For example, the method could use supervised learning algorithms to train a model that predicts the most likely vehicle association for a given transaction based on features such as the driver, location, timestamp, and other contextual data. This model could be continuously refined and updated as new data becomes available, allowing the method to adapt to changing patterns and behaviors over time.

Furthermore, the use of a hierarchical matching approach allows for a more efficient and scalable processing of transactions. By applying the matching techniques, the method can quickly rule out unlikely vehicle associations and focus on the most promising candidates. This can significantly reduce the computational resources required to process large volumes of transactions, enabling the method to handle the scale and complexity of modern fleet operations.

In addition to its technical merits, this method also has important implications for fleet management and optimization. By accurately associating transactions with vehicles, the method can provide fleet managers with a more complete and granular view of their operations. This can help them identify opportunities for cost savings, such as by optimizing fuel purchases or reducing idle time. It can also help them monitor driver behavior and compliance with regulations, such as hours of service limits and safety protocols.

Moreover, the ability to analyze transaction data at the vehicle level can enable more advanced forms of optimization, such as predictive maintenance and dynamic routing. For example, by analyzing the fuel consumption and other performance metrics of individual vehicles, the method could predict when a vehicle is likely to require maintenance and proactively schedule repairs to minimize downtime. Similarly, by analyzing the location and timing of transactions, the method could recommend more efficient routes and schedules that reduce fuel consumption and improve overall fleet efficiency.

Overall, the method illustrated in FIG. 3 represents a technical advancement in the field of fleet management and optimization. By leveraging advanced techniques such as real-time location tracking, machine learning, and hierarchical matching, this method enables a more accurate, efficient, and scalable processing of transaction data. This, in turn, provides fleet managers with the insights and tools they need to optimize their operations, reduce costs, and improve overall performance.

In some implementations, the method can be further enhanced and extended in various ways. For example, the method could incorporate additional data sources, such as weather and traffic data, to provide even more context and insight into fleet operations.

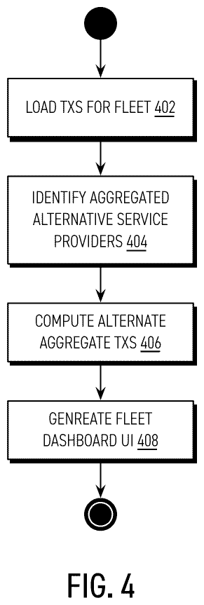

FIG. 4 illustrates a flow diagram of a method for generating a fleet dashboard that provides an aggregated view of optimization opportunities across multiple transactions and vehicles.

This method builds upon the individual transaction optimization process described in FIG. 2, allowing fleet managers to gain a high-level understanding of their entire fleet's performance and identify areas for improvement.

The method begins at step 402, where the method can load transactions for a specific fleet over a given time period. This step involves querying the transaction database and retrieving all relevant records associated with the fleet's vehicles and drivers. The method may apply various filters and aggregations to the raw transaction data to extract insights and patterns. For example, it may group transactions by vehicle type, driver, or location to identify trends and anomalies that warrant further investigation.

Next, at step 404, the method can identify aggregated alternative service providers across all the loaded transactions. This step leverages the individual transaction optimization process described in FIG. 2, but applies it at a fleet-wide level. The method can analyze each transaction to determine if there were alternative service providers that could have been used to optimize the transaction's cost or performance. It then aggregates these findings to identify the most significant optimization opportunities across the entire fleet.

To perform this aggregation, the method may employ various data processing and analysis techniques. For example, it may use clustering algorithms to group similar transactions based on their location, time, or other attributes, and then identify common alternative service providers within each cluster. It may also use association rule mining to discover frequent patterns and correlations among the transactions and their associated alternative service providers.

Once the aggregated alternative service providers have been identified, the method proceeds to step 406, where it computes alternate aggregate transactions. This step involves simulating the potential outcomes of optimizing each transaction based on the identified alternative service providers, and then aggregating these results to estimate the overall impact on the fleet's performance.

To compute the alternate aggregate transactions, the method may use optimization and simulation techniques. For example, it may formulate the problem as a multi-objective optimization model, where the goal is to minimize the total cost of the transactions while also considering other factors such as time, distance, and driver satisfaction. The method may then solve this model using mathematical programming or metaheuristic algorithms to find the optimal combination of alternative service providers for each transaction.

Alternatively, the method may use Monte Carlo simulation to generate a large number of potential scenarios based on different combinations of alternative service providers, and then analyze the distribution of outcomes to estimate the most likely impact on the fleet's performance. This approach can help fleet managers understand the range of possible outcomes and make more informed decisions based on their risk tolerance and other strategic considerations.

After computing the alternate aggregate transactions, the method can move to step 408, where it generates the fleet dashboard user interface (UI). This step involves presenting the insights and recommendations generated by the previous steps in a clear, concise, and actionable format that enables fleet managers to quickly understand their fleet's performance and identify opportunities for optimization.

The fleet dashboard UI may include a variety of visual elements and interactive features that allow fleet managers to explore the data and gain deeper insights. For example, it may include high-level metrics and key performance indicators (KPIs) that provide a snapshot of the fleet's overall performance, such as the total cost of transactions, the average cost per mile, and the percentage of transactions that were optimized. These metrics may be presented using intuitive visualizations such as gauges, charts, and tables that highlight trends and anomalies. In some implementations, the UI can include detailed breakdowns and drill-downs that allow fleet managers to explore the data at a more granular level, such as by vehicle type, driver, or location. These breakdowns may be presented using interactive charts and graphs that allow users to filter, sort, and group the data based on different criteria. In some implementations, the visual elements can include geospatial visualizations that show the location and distribution of transactions and alternative service providers on a map. These visualizations may use color-coding, clustering, and other techniques to highlight patterns and anomalies in the data, such as areas with high concentrations of missed optimization opportunities. In some implementations, the visual elements can include personalized recommendations and alerts that provide fleet managers with actionable insights and suggestions for optimization. For example, the method may identify specific drivers or vehicles that consistently miss optimization opportunities, and suggest targeted coaching or training interventions to improve their performance. It may also alert fleet managers to significant changes or anomalies in the data, such as a sudden increase in fuel prices or a decline in optimization rates. The fleet dashboard UI can also provide personalized views and reports based on user personas, such as drivers, fleet managers, and group-level users. This enables each user to access the information most relevant to their role and responsibilities, enhancing the usability and effectiveness of the system

One of the key technical challenges in generating the fleet dashboard UI is ensuring that the insights and recommendations are both accurate and actionable. To address this challenge, the method may employ various data quality and validation techniques, such as outlier detection, data cleaning, and statistical significance testing, to ensure that the data is reliable and free from errors or biases. It may also use machine learning and natural language processing techniques to generate human-readable insights and recommendations that are tailored to the specific needs and preferences of each fleet manager.

Another important consideration is the need to balance the trade-off between providing comprehensive and detailed information, and avoiding information overload or analysis paralysis. To strike this balance, the method may use progressive disclosure and drill-down techniques that allow users to start with a high-level overview of the data and then gradually explore deeper insights and recommendations as needed. It may also use data storytelling and visualization techniques that focus on the most important and actionable insights, rather than overwhelming users with raw data or irrelevant details.

Ultimately, the goal of the fleet dashboard UI is to provide fleet managers with a powerful and intuitive tool for optimizing their operations and making data-driven decisions. By presenting insights and recommendations in a clear, concise, and actionable format, the dashboard can help fleet managers identify opportunities for cost savings, performance improvements, and risk mitigation that might otherwise go unnoticed.

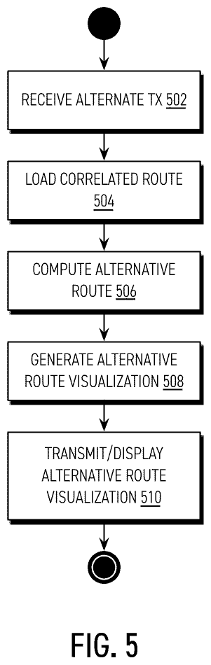

FIG. 5 illustrates a flow diagram of a method for generating and visualizing alternative routes based on the optimized transactions identified in the previous steps.

The method begins at step 502, where the method receives an alternate data log entry that has been optimized based on the identification of alternative service providers, as described in FIG. 2 and FIG. 4. This alternate data log entry represents a potential opportunity for cost savings or performance improvements, such as filling up at a cheaper gas station or avoiding a congested area during peak hours.

Next, at step 504, the method loads the correlated route data associated with the original transaction. This data may include information such as the origin and destination of the trip, the expected travel time and distance, and any additional waypoints or constraints that need to be considered. The method may retrieve this data from a variety of sources, such as GPS tracking devices, electronic logging devices (ELDs) or dashcams, or transportation management systems.

Once the correlated route data has been loaded, the method proceeds to step 506, where it can compute an alternative route based on the optimized transaction. This step involves applying routing algorithms and optimization techniques to determine the most efficient and cost-effective path between the origin and destination, taking into account the location and characteristics of the alternative service provider identified in the optimized transaction.

To compute the alternative route, the method may use a variety of approaches, depending on the complexity and scale of the problem. For simpler cases, such as a single alternative service provider along a straightforward route, the method may use graph traversal algorithms like Dijkstra's algorithm or A* search to find the shortest path between the origin and destination that passes through the alternative service provider.

For more complex cases, such as multiple alternative service providers, time-dependent travel costs, or dynamic traffic conditions, the method may use more advanced optimization techniques such as integer programming, metaheuristics, or reinforcement learning. These techniques can help the method find near-optimal solutions to the routing problem in real-time, while also adapting to changing conditions and learning from past experiences.

One approach may be to use multi-objective optimization, which allows the method to balance multiple competing objectives, such as minimizing fuel consumption, reducing travel time, and maximizing driver satisfaction, while also taking into account various constraints and uncertainties. By framing the routing problem as a multi-objective optimization model, the method can generate a set of Pareto-optimal solutions that represent the best trade-offs between different objectives, allowing fleet managers and drivers to make informed decisions based on their specific priorities and preferences.

Another consideration in computing the alternative route is the need to ensure the feasibility and safety of the recommended path. To address this, the method may incorporate various data sources and constraints, such as road network data, weather data, and vehicle specifications, to ensure that the alternative route is physically possible and legally compliant for the specific vehicle and driver. The method may also use machine learning techniques, such as anomaly detection and predictive maintenance, to identify potential hazards or breakdowns along the route and suggest proactive measures to mitigate these risks.

After computing the alternative route, the method moves to step 508, where it can generate an alternative route visualization that clearly and intuitively communicates the recommended path to the driver and fleet manager. This visualization may take many forms, depending on the specific use case and user preferences, but typically includes a map-based representation of the route, along with key metrics and indicators such as estimated travel time, fuel consumption, and cost savings.

To generate the alternative route visualization, the method may use a variety of data visualization and user interface design techniques. For example, it may use color-coding and iconography to highlight the location and characteristics of the alternative service provider, as well as any potential hazards or points of interest along the route. It may also use animation and interactive features, such as pan and zoom controls, to allow users to explore the route in more detail and see how it evolves over time.

In addition to the map-based visualization, the method may also generate a variety of other visual and textual elements to provide additional context and guidance to the user. For example, it may include a turn-by-turn navigation interface that provides step-by-step instructions for following the recommended route, as well as voice prompts and alerts to help drivers stay on track. It may also include a dashboard view that displays key performance metrics and indicators, such as the estimated fuel savings and CO2 emissions reduction associated with the alternative route, as well as any relevant benchmarks or targets.

To ensure the quality and effectiveness of the alternative route visualization, the method may employ various data visualization best practices and user testing techniques. For example, it may use a consistent and intuitive visual language across all elements of the visualization, with clear labels and annotations to help users understand the meaning and context of the data. It may also conduct user testing and feedback sessions to gather insights and identify areas for improvement, using techniques such as A/B testing, eye tracking, and user interviews to optimize the design and usability of the visualization.

Once the alternative route visualization has been generated, the method proceeds to step 510, where it transmits or displays the visualization to the driver and/or fleet manager. This step may involve a variety of delivery channels and technologies, depending on the specific use case and user preferences.

For drivers, the alternative route visualization may be delivered through an in-vehicle dashcam display or mobile app, using technologies such as GPS navigation systems, smartphone apps, or head-up displays. These delivery channels can provide drivers with real-time guidance and updates on the recommended route, as well as alerts and notifications for any changes or deviations from the planned path.

For fleet managers, the alternative route visualization may be integrated into a web-based dashboard or reporting tool, using technologies such as data visualization libraries, business intelligence platforms, or geographic information systems (GIS). These tools can provide fleet managers with a high-level overview of the alternative routes being recommended across their entire fleet, as well as drill-down capabilities to explore specific routes or vehicles in more detail.

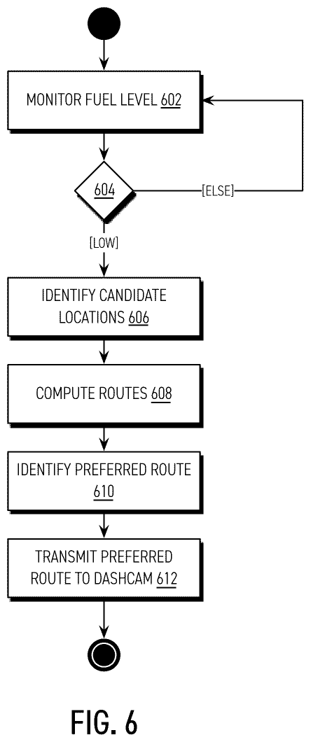

FIG. 6 illustrates a flow diagram of a method for providing real-time fuel optimization recommendations to drivers based on their current fuel level and location.

The method begins at step 602, where the method continuously monitors the fuel level of the vehicle using a variety of sensors and data sources. This monitoring process may involve the use of advanced telematics devices, such as fuel level sensors, engine control modules (ECMs), and onboard diagnostics (OBD) systems, which can provide real-time data on the vehicle's fuel consumption, efficiency, and remaining range. The method may also integrate with other data sources, such as fleet management software, fuel card transactions, and driver input, to provide a more comprehensive and accurate picture of the vehicle's fuel status.

To enable this real-time fuel monitoring, the method may employ various data acquisition, processing, and storage technologies, such as edge computing, streaming data processing, and time-series databases. These technologies can help the method efficiently collect, analyze, and store large volumes of fuel data from multiple vehicles in real-time, while also ensuring data quality, security, and privacy.

Once the fuel level data has been acquired and processed, the method proceeds to step 604, where it checks whether the fuel level has dropped below a predefined threshold, indicating that the vehicle needs to refuel soon. This threshold may be based on a variety of factors, such as the vehicle's fuel tank capacity, average fuel consumption, and remaining range, as well as any user-defined preferences or constraints. Alternatively, or in conjunction with the foregoing, the predefined threshold can be learned on a per-driver or per-fleet basis. For example, the method can monitor fuel levels when a particular driver refuels and determine an average fuel level that causes the driver to re-fuel (as different drivers may prefer to refuel at different fuel levels). In some implementations, this averaged (or otherwise predicted) fuel level can be used as the predefined threshold either on a per-driver or fleet-wide fuel level.

If the fuel level is above the threshold, the method loops back to step 602 and continues monitoring the fuel level until it drops below the threshold. However, if the fuel level is below the threshold, the method moves on to step 606, where it identifies candidate refueling locations based on the vehicle's current location and route.

To identify candidate refueling locations, the method may use a combination of geospatial analysis, machine learning, and optimization techniques. For example, it may use geographic information systems (GIS) and spatial databases to identify all gas stations and refueling points within a certain radius of the vehicle's current location, taking into account factors such as distance, accessibility, and amenities. It may also use historical data and predictive modeling to estimate the fuel prices and wait times at each location, as well as any potential discounts or loyalty programs available to the driver.

In addition to these static factors, the method may also consider dynamic and real-time factors, such as traffic conditions, weather patterns, and road closures, which can impact the feasibility and desirability of different refueling options. To incorporate these dynamic factors, the method may use advanced data fusion and machine learning techniques, such as Kalman filtering, Bayesian networks, and deep learning, to continuously update and refine its recommendations based on the latest available data.

After identifying a set of candidate refueling locations, the method moves to step 608, where it computes potential routes to each location based on the vehicle's current position and destination. This step involves the use of advanced routing and navigation algorithms, such as Dijkstra's algorithm, A* search, or contraction hierarchies, which can efficiently find the shortest, fastest, or most fuel-efficient path between two points on a road network.

To compute these routes, the method may leverage a variety of data sources and technologies, such as digital maps, GPS, and traffic data feeds, as well as more advanced techniques like machine learning and artificial intelligence. For example, it may use reinforcement learning algorithms to continuously optimize the routing strategy based on driver feedback and historical performance data, or use computer vision and natural language processing to interpret and incorporate real-time traffic signs, road conditions, and driver instructions.

Once the potential routes have been computed, the method proceeds to step 610, where it identifies the preferred route based on a variety of criteria and constraints. These criteria may include factors such as the total distance, estimated fuel consumption, travel time, and cost of each route, as well as any driver preferences or constraints, such as the need to arrive at a certain time or avoid certain types of roads.

To identify the preferred route, the method may use advanced optimization and decision-making techniques, such as multi-objective optimization, goal programming, or the analytic hierarchy process (AHP). These techniques can help the method find the route that best balances the various criteria and constraints, while also taking into account any uncertainties or trade-offs involved. For example, the method may use a multi-objective genetic algorithm to find the Pareto-optimal set of routes that minimize both fuel consumption and travel time, while also satisfying any constraints on distance or cost. Or it may use a fuzzy AHP approach to systematically evaluate and rank the different routes based on the driver's subjective preferences and the method's objective performance metrics.

Once the preferred route has been identified, the method moves on to step 612, where it transmits the route information to the vehicle's dashcam or other in-vehicle display system. For example, the method may use a cellular or satellite network to send the route data to the vehicle's onboard computer or mobile device, which can then display the information on a dashboard screen, heads-up display, or smartphone app. Alternatively, or in conjunction with the foregoing, the method may transmit route information to a driver's mobile application as part of step 612.

In addition to the basic route information, the method may also provide the driver with a range of value-added services and features, such as turn-by-turn navigation, voice guidance, and real-time traffic updates, to make the refueling process as smooth and efficient as possible. It may also use gamification and incentive techniques, such as rewards points, achievements, and leaderboards, to encourage drivers to follow the recommended routes and adopt more fuel-efficient driving behaviors.

In some implementations, the same method could also be used to provide predictive and proactive fuel optimization recommendations to drivers and fleet managers. For example, if a driver is planning a long trip that exceeds the vehicle's current fuel range, the method could automatically identify and recommend the best refueling locations and routes based on the driver's planned itinerary, preferences, and constraints. To enable this predictive optimization, the method could leverage a range of advanced data analytics and machine learning techniques, such as time-series forecasting, sequence mining, and deep learning. For example, it could use recurrent neural networks (RNNs) or long short-term memory (LSTM) models to predict the driver's future fuel consumption and refueling needs based on their historical driving patterns, route characteristics, and external factors like weather and traffic conditions. The method could also use reinforcement learning and decision optimization techniques to continuously improve and adapt its refueling recommendations based on the driver's feedback and actual performance data. For example, if a driver consistently ignores or overrides the system's recommendations, the method could use this feedback to adjust its algorithms and parameters, or to provide more personalized and context-aware suggestions in the future. The proactive fuel optimization capabilities of the system can also leverage the reactive missed savings data to generate savings finder recommendations. These recommendations can be used for automated driver coaching campaigns and analytics, identifying savings along a route based on tank level, suggesting savings at the beginning or end of a day or shift, and providing vicinity-based special savings offers. By utilizing the historical missed savings data, the system can continuously refine and improve its proactive recommendations, driving further cost savings for the fleet.

As transportation and logistics industries continue to evolve and face new challenges, such as the transition to electric and autonomous vehicles, the need for intelligent and adaptive fuel optimization solutions will only continue to grow. By providing a robust and flexible platform for real-time and predictive fuel management, this method can help organizations stay ahead of the curve and drive significant improvements in their operational efficiency, cost savings, and environmental performance.

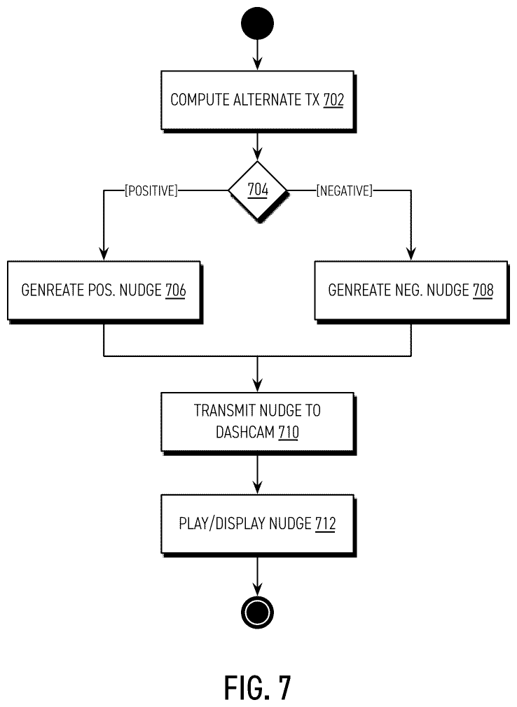

FIG. 7 illustrates a flow diagram of a method for generating and delivering real-time driver feedback and coaching based on their fuel optimization performance.

The method begins at step 702, where the method computes an alternate data log entry based on the driver's actual fuel purchase and the available fuel optimization opportunities at nearby locations. This computation involves the use of algorithms and data models to estimate the potential cost savings, time savings, and environmental benefits that the driver could have achieved by choosing a different refueling location or route.

To perform this computation, the method may leverage a range of data sources and analytical techniques, such as spatial data analysis, using geographic information systems (GIS) and spatial databases to identify and compare fuel prices, amenities, and other attributes of nearby gas stations and refueling points. In some implementations, the method can use machine learning to apply predictive models and algorithms, such as regression, decision trees, or neural networks, to estimate the fuel consumption, travel time, and other performance metrics associated with different refueling options. In some implementations, the method can use optimization techniques such as linear programming, dynamic programming, or metaheuristics, to find the best combination of refueling location, route, and timing that maximizes the driver's overall utility or performance. By integrating these various data sources and analytical methods, the method can generate a comprehensive and accurate assessment of the driver's fuel optimization performance, taking into account a wide range of factors and constraints.

Once the alternate data log entry has been computed, the method proceeds to step 704, where it determines whether the driver's actual performance was better or worse than the optimal scenario. This determination involves comparing the key performance metrics, such as cost savings, time savings, and environmental impact, between the actual and alternate data log entries.

If the driver's actual performance was better than the alternate scenario, the method moves on to step 706, where it generates a positive feedback message or “nudge” to reinforce the driver's good behavior. This nudge could take the form of a congratulatory message, a virtual reward or badge, or a social media post highlighting the driver's achievement.

To generate these positive nudges, the method may use natural language generation (NLG) techniques, such as template-based or rule-based systems, to create personalized and contextually relevant messages for each driver. For example, the method might generate a message like: “Great job, John! You saved $5 and 10 minutes by refueling at the Acme Gas Station on your last trip. Keep up the good work!”

The method may also use gamification and incentive design principles to make the positive feedback more engaging and motivating for drivers. For example, it could assign points or badges to drivers based on their cumulative fuel optimization performance, or create leaderboards and competitions that showcase the top-performing drivers across different metrics.

On the other hand, if the driver's actual performance was worse than the alternate scenario, the method moves on to step 708, where it generates a negative feedback message or “nudge” to encourage the driver to improve their behavior. This nudge could take the form of a constructive criticism, a suggestion for improvement, or a reminder of the potential benefits of fuel optimization.

To generate these negative nudges, the method may use NLG techniques, such as deep learning or reinforcement learning, to create more nuanced and personalized messages that take into account the driver's individual characteristics, preferences, and past behavior. For example, the method might generate a message like: “Hey John, we noticed that you missed an opportunity to save $5 and 10 minutes by refueling at the Acme Gas Station on your last trip. Next time, try using our fuel optimization app to find the best deals and routes in real-time!”

The method may also use principles from behavioral economics and persuasive technology to make the negative feedback more effective and actionable for drivers. For example, it could use loss aversion or social proof techniques to highlight the potential costs or peer comparisons associated with suboptimal fuel behavior, or provide specific and achievable goals or challenges for drivers to work towards.

Regardless of whether the feedback is positive or negative, the method proceeds to step 710, where it transmits the generated nudge to the vehicle's dashcam or other in-vehicle display system. This transmission involves the use of wireless communication technologies, such as cellular, Wi-Fi, or Bluetooth, to send the feedback data from the system's servers to the vehicle's onboard computer or mobile device.

Once the feedback data has been transmitted to the vehicle, the method moves on to step 712, where the dashcam or display system plays back or displays the feedback to the driver in real-time. This playback could take the form of an audio message, a visual alert, or a combination of both, depending on the driver's preferences and the vehicle's capabilities. Alternatively, or in conjunction with the foregoing, the method may transmit the feedback to a driver's mobile application as part of step 612.

To enhance the impact and memorability of the feedback, the method may use advanced multimedia technologies, such as speech synthesis, computer graphics, or augmented reality, to create more engaging and immersive user experiences. For example, the method could use a realistic avatar or virtual assistant to deliver the feedback in a conversational and empathetic tone, or overlay the feedback information on the driver's field of view using a heads-up display or windshield projection system.

The method may also use machine learning and data analytics techniques to optimize the timing, frequency, and format of the feedback based on the driver's individual characteristics and past responses. For example, it could use a reinforcement learning algorithm to dynamically adjust the feedback strategy based on the driver's real-time performance and engagement metrics, or a collaborative filtering approach to recommend feedback styles and modalities that have been effective for similar drivers in the past.

By providing drivers with timely, personalized, and actionable feedback on their fuel optimization performance, this method can help to promote more efficient and sustainable driving behaviors in real-time, leading to significant cost savings, productivity gains, and environmental benefits for fleet operators and society as a whole.

In some implementations, the method could be extended and enhanced in various ways to provide even more sophisticated and effective driver coaching and optimization capabilities. For example, the method could integrate additional data sources and sensors, such as traffic cameras, weather stations, or driver biometrics, to provide more comprehensive and contextual feedback that takes into account the full range of factors affecting driver performance and well-being. As another example, the method could use more advanced machine learning and artificial intelligence techniques, such as deep reinforcement learning, transfer learning, or explainable AI, to create more intelligent and transparent feedback models that can adapt to new drivers, vehicles, or environments with minimal manual intervention. As another example, the method could incorporate social and collaborative features, such as peer feedback, group challenges, or online forums, to foster a sense of community and mutual support among drivers, and encourage the sharing of best practices and lessons learned. As another example, the method could be extended to other areas of driver performance and safety, such as eco-driving, defensive driving, or distracted driving, to provide a more holistic and integrated approach to driver coaching and management.

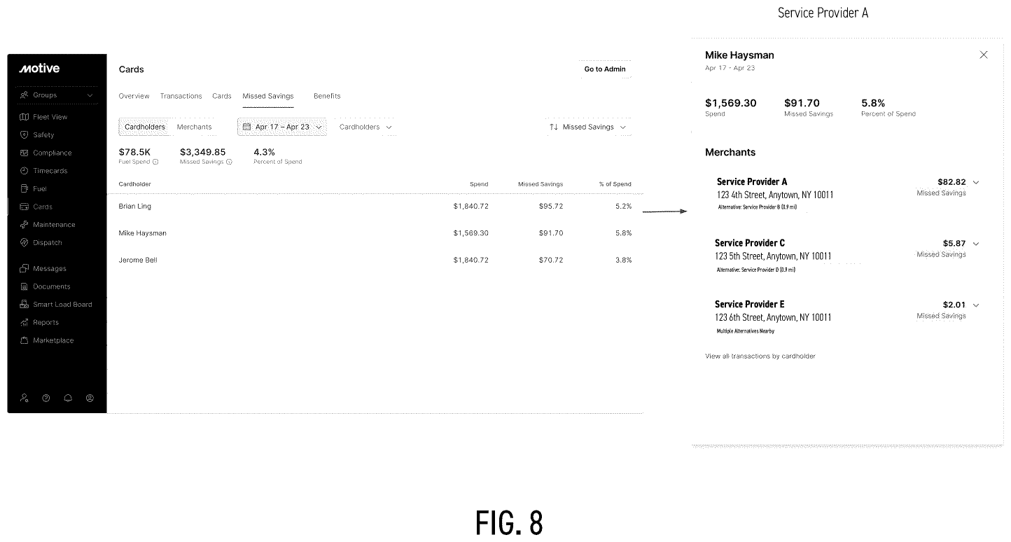

FIG. 8 is a UI diagram illustrating a driver dashboard and selected driver according to some of the disclosed embodiments.

The illustrated dashboard includes a navigation menu on the left side, allowing users to access various features and sections of the application, such as the fleet view, safety, compliance, timecards, fuel, cards, maintenance, dispatch, and reports.

The main section of the dashboard displays a summary of key metrics for the selected group and date range, including the total fuel spend, missed savings amount and percentage. Below the summary, there is a tabular view of individual cardholders and their respective spend and missed savings data. Each row in the table corresponds to a specific cardholder and includes their name, total spend, missed savings amount, and missed savings percentage.

On the right side of the dashboard, there is an expanded view panel that provides more detailed information for a selected cardholder. The expanded view displays the total spend, missed savings amount, and missed savings percentage specific to the selected cardholder.

Additionally, the expanded view includes a list of service providers where the selected cardholder had potential savings opportunities. Each service provider entry shows the name and location of the service provider, along with the missed savings amount that could have been achieved by choosing an alternative service provider. For example, the entry “Service Provider A, 123 4th Street, Anytown, NY 10011” indicates that the cardholder could have saved $82.82 by selecting an alternative service provider, “Service Provider B (0.9 mi).”

The service provider list in the expanded view provides actionable insights for fleet managers, allowing them to identify specific instances where cardholders missed potential savings and to guide them towards more cost-effective choices in the future. By presenting this information in a clear and concise manner, the dashboard enables fleet managers to quickly pinpoint areas for improvement and take targeted actions to optimize their fleet's fuel spending.

Overall, the fleet dashboard UI illustrated in FIG. 8 serves as a tool for fleet managers to monitor and optimize fuel spending across their fleet. By aggregating data from multiple cardholders and service providers and presenting it in a user-friendly format, the dashboard facilitates data-driven decision-making and supports continuous improvement efforts in fleet fuel management.

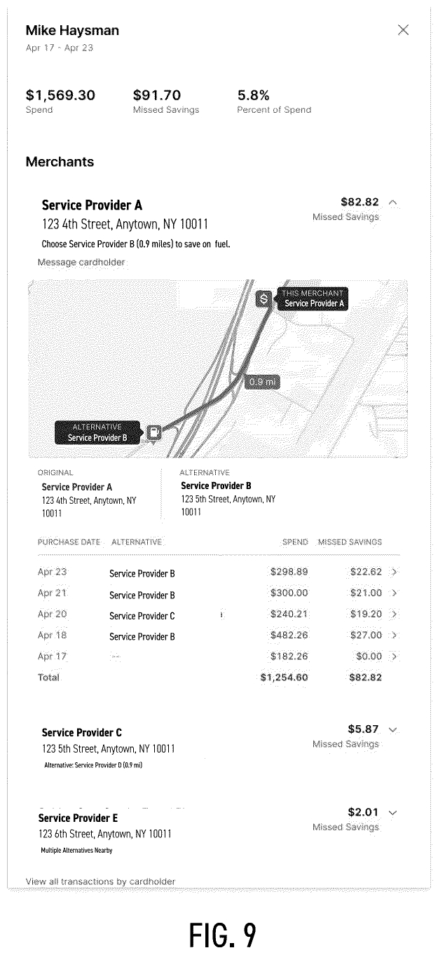

FIG. 9 is a UI diagram illustrating a selected driver and expanded service provider alternative according to some of the disclosed embodiments.

The illustrated figure builds upon the concepts illustrated in FIG. 8, providing a more granular and actionable perspective on a specific driver's missed savings opportunities. The top section of the UI displays a summary of the selected driver's key metrics, including their total spend, missed savings amount, and the percentage of spend that could have been saved by choosing alternative service providers. This high-level overview allows fleet managers to quickly assess the driver's overall performance and identify potential areas for improvement.

Below the summary, there is a list of service providers where the driver had missed savings opportunities. Each service provider entry includes the name, location, and the amount of missed savings associated with that particular service provider. In the example shown, the service provider “Service Provider A” at “123 4th Street, Anytown, NY 10011” is expanded to reveal additional details.

The expanded view of the selected service provider provides a wealth of information to help fleet managers understand the specific missed savings opportunity and take corrective action. At the top of the expanded view, there is a clear recommendation for the driver, stating “Go to Service Provider B (0.9 miles) instead to save $63.62 on fuel.” This actionable insight is designed to guide the driver towards a more cost-effective alternative for future fuel purchases.

To further support this recommendation, the UI includes an interactive map that visually illustrates the locations of the original service provider (Service Provider A) and the recommended alternative (Service Provider B). The map provides a clear and intuitive way for the driver to understand the proximity and route to the alternative service provider, making it easier for them to make informed decisions in real-time.

Below the map, there is a table that displays the driver's past transactions at the original service provider, Service Provider A. Each row in the table represents a specific transaction and includes details such as the purchase date, total spend, missed savings amount, and the recommended alternative for that particular transaction. This historical data helps fleet managers and drivers identify patterns in the driver's fueling behavior and highlights recurring missed savings opportunities.

The UI also includes a “View all transactions of this cardholder” link, allowing fleet managers to access a complete history of the driver's transactions and gain a more comprehensive understanding of their spending habits and potential areas for optimization. Overall, the UI diagram in FIG. 9 provides a tool for fleet managers to drill down into specific drivers' missed savings opportunities and take targeted actions to improve their fueling decisions. By combining high-level summaries, actionable recommendations, interactive visualizations, and historical transaction data, this interface enables data-driven coaching and supports continuous improvement efforts in fleet fuel management.

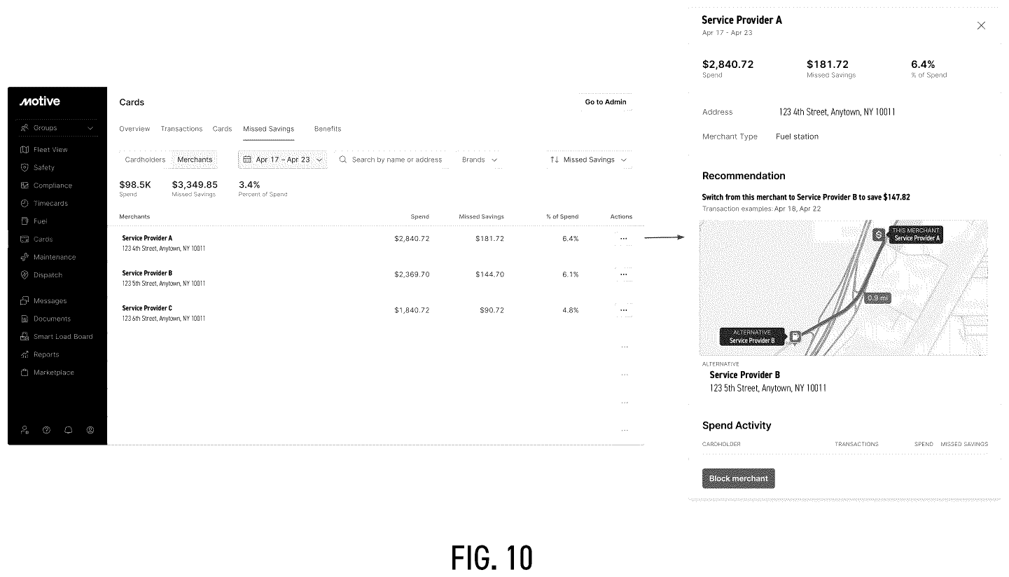

FIG. 10 is a UI diagram illustrating a cardholder dashboard and selected service provider according to some of the disclosed embodiments.

The illustrated figure builds upon the concepts introduced in FIG. 8 but shifts the perspective from driver-level insights to a service provider-centric view, enabling fleet managers to identify and optimize fuel spending at specific service providers.

The UI is divided into several sections, each designed to provide a comprehensive overview of the fleet's fuel spending and potential savings opportunities. Similar to FIG. 8, the left side of the screen features a navigation menu that allows users to access various features and functionalities of the fleet management application, such as the fleet view, safety, compliance, timecards, fuel, cards, maintenance, dispatch, and reporting modules. The main section of the dashboard is dedicated to the missed savings summary for service providers. It displays key metrics for the selected date range, including the total spend, missed savings amount, and the percentage of spend that could have been saved by choosing alternative service providers. This high-level summary enables fleet managers to assess the overall performance of their fleet in terms of fuel cost optimization.

Below the summary, there is a tabular view that lists individual service providers and their corresponding missed savings data. Each row in the table represents a specific service provider and includes details such as the service provider's name, total spend, missed savings amount, and the percentage of spend that could have been optimized. The table is sorted by default to show the service providers with the highest missed savings amounts first, allowing fleet managers to prioritize their efforts and focus on the most significant opportunities for cost reduction.

The UI provides several filtering and search options to help fleet managers navigate and analyze the data effectively. Users can filter the data by date range, search for specific service providers by name or address, and even filter by service provider type (e.g., fuel stations) or brand. These features enable fleet managers to drill down into specific subsets of data and gain more targeted insights into their fleet's fueling patterns and savings opportunities.

On the right side of the screen, there is an expanded view panel that provides detailed information about a selected service provider, in this case, “Service Provider A” located at “123 4th Street, Anytown, NY 10011”. This expanded view offers a closer look at the missed savings associated with this particular service provider, including the total spend, missed savings amount, and the percentage of spend that could have been optimized. One of the features of the expanded view is the actionable recommendation it provides to fleet managers. In the example shown, the UI suggests: “Switch from this service provider to Service Provider B to save $147.82”. This clear and concise recommendation is designed to guide fleet managers towards more cost-effective fueling options and help them realize significant savings over time. To support this recommendation, the expanded view includes an interactive map that visually depicts the locations of the original service provider (Service Provider A) and the recommended alternative (Service Provider B). The map offers a user-friendly way to understand the geographical context and proximity of the two service providers, enabling fleet managers to make informed decisions about optimizing their fueling strategies.

Below the map, the UI presents a comparison table that highlights the key differences between the original service provider and the recommended alternative. The table includes metrics such as the spend amount, missed savings, and the percentage of spend that could be optimized by switching to the alternative provider. This side-by-side comparison makes it easy for fleet managers to understand the potential impact of their fueling choices and motivates them to take action. The expanded view also features a “Block service provider” button, which allows fleet managers to proactively prevent their drivers from fueling at the selected service provider in the future. This functionality is particularly useful for high-spend, low-savings service providers that consistently underperform in terms of cost-effectiveness. By blocking these service providers, fleet managers can actively steer their drivers towards more optimal fueling options and ensure long-term savings.

In addition to the service provider-level insights, the UI provides a consolidated view of the spend activity across all transactions associated with the selected service provider. The spend activity section displays a breakdown of the total spend, transactions, and missed savings amounts, offering a comprehensive picture of the fleet's fueling behavior at that particular service provider.

The UI may also incorporate data visualization techniques to enhance the user experience and facilitate data-driven decision-making. For instance, the spend activity section can include a bar chart that visually represents the distribution of spend across different categories, such as cardholder transactions and missed savings. This visual representation allows fleet managers to quickly identify patterns and trends in their fueling data, enabling them to make more informed optimization decisions.

Overall, the cardholder dashboard UI illustrated in FIG. 10 serves as a tool for fleet managers to optimize their fuel spending at the service provider level. By providing a comprehensive view of missed savings opportunities, actionable recommendations, and interactive visualizations, this interface empowers fleet managers to make data-driven decisions and implement effective cost-saving strategies. The service provider-centric approach showcased in this UI complements the driver-level insights presented in previous figures, offering a holistic view of the fleet's fueling performance. By analyzing data from both perspectives, fleet managers can identify systemic issues, implement targeted interventions, and drive continuous improvement in their fuel management practices. Furthermore, the UI's ability to block underperforming service providers (i.e., by blocking transactions) demonstrates a proactive and strategic approach to fuel cost optimization. By leveraging this feature, fleet managers can actively shape their drivers' fueling behavior and steer them towards more cost-effective options, resulting in significant long-term savings for the organization.

In conclusion, the cardholder dashboard UI presented in FIG. 10 represents a sophisticated and user-centric solution for optimizing fuel spending at the service provider level. By combining advanced data analytics, intuitive visualizations, and actionable recommendations, this interface enables fleet managers to make informed decisions, implement effective cost-saving strategies, and drive continuous improvement in their fuel management practices. As such, it constitutes a significant advancement in the field of fleet optimization and sets a new standard for data-driven decision-making in the transportation industry.

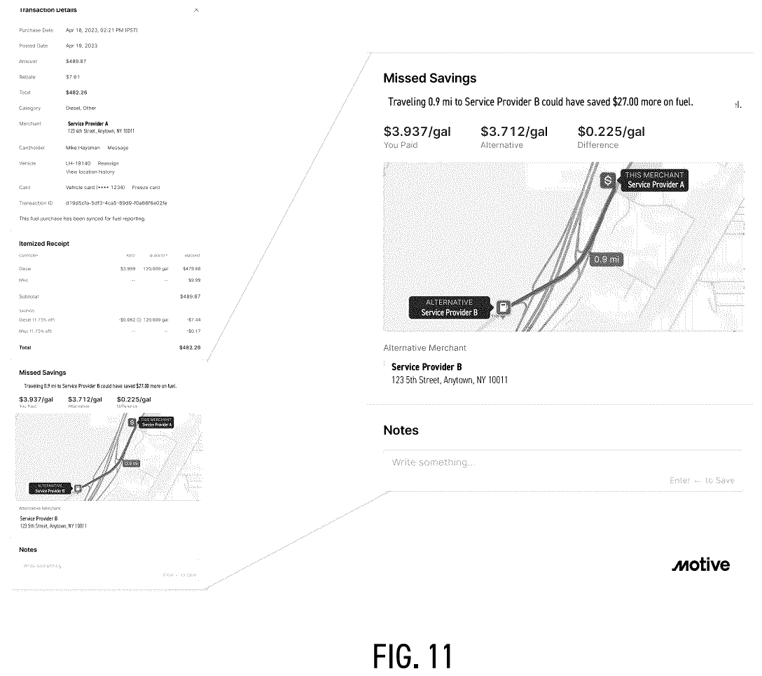

FIG. 11 is a UI diagram illustrating an individual transaction and alternative transaction according to some of the disclosed embodiments.

The UI is divided into several sections, each designed to offer a comprehensive overview of the selected transaction and its potential for cost optimization. At the top of the screen, the transaction details are prominently displayed, including key information such as the purchase date, posted date, amount, rebate, and category. These details provide essential context for understanding the nature and significance of the transaction.

Below the transaction details, the UI presents a summary of the missed savings associated with this particular transaction. The summary includes the actual amount paid for the fuel purchase and the potential savings that could have been achieved by opting for an alternative service provider. In the example shown, the UI indicates that “Traveling 0.9 mi to Service Provider B could have saved $27.00 more on fuel.” This clear and concise statement highlights the magnitude of the missed savings opportunity and emphasizes the importance of service provider selection in fuel cost optimization.

To further illustrate the potential savings, the UI includes a breakdown of the missed savings across three key metrics: price per gallon, alternative price per gallon, and the difference in price per gallon. These metrics provide a more nuanced understanding of the cost differential between the original service provider and the recommended alternative, allowing fleet managers to assess the significance of the missed savings opportunity.

The UI further includes an interactive map that visually depicts the location of the original service provider (Service Provider A) and the recommended alternative (Service Provider B). The map offers a representation of the geographical context, enabling fleet managers to evaluate the feasibility and convenience of the alternative service provider. By presenting the distance between the two service providers (0.9 mi), the UI helps fleet managers weigh the potential savings against the additional travel time and distance required to reach the alternative location.

Below the map, the UI provides additional details about the recommended alternative service provider, including its name, address, and contact information. This information is crucial for fleet managers who wish to investigate further or provide specific guidance to their drivers regarding the preferred fueling location. The UI also includes a “Notes” section, which allows fleet managers to input and save custom notes or comments related to the transaction. This feature enables users to document any relevant observations, follow-up actions, or contextual information that may be useful for future reference or analysis.

Overall, the individual transaction view presented in FIG. 11 provides a comprehensive and actionable perspective on missed savings opportunities at the most granular level. By offering detailed transaction information, clear savings metrics, interactive visualizations, and convenient input options, this UI empowers fleet managers to thoroughly analyze and optimize fuel spending on a per-transaction basis. As such, it represents a tool for driving cost savings and efficiency in fleet fuel management. The granular insights provided by this UI complement the higher-level views presented in previous figures, allowing fleet managers to approach fuel cost optimization from multiple angles. By drilling down to individual transactions, managers can identify specific instances of suboptimal fueling decisions, investigate the underlying causes, and take targeted corrective actions. This level of detail is essential for fostering a culture of continuous improvement and accountability within the fleet management organization.

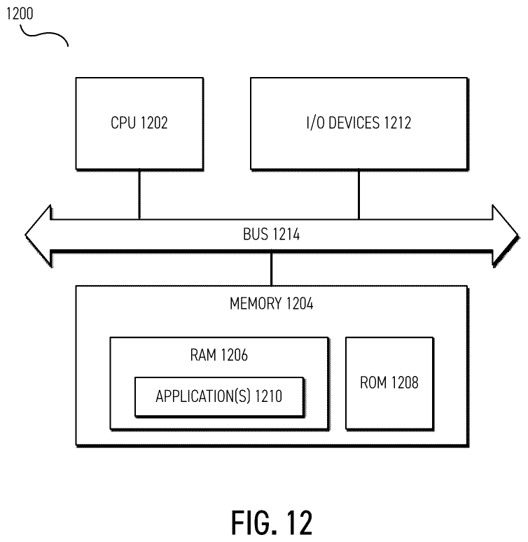

FIG. 12 is a block diagram of a computing device according to some embodiments of the disclosure.

As illustrated, the device 1200 includes a processor or central processing unit (CPU) such as CPU 1202 in communication with a memory 1204 via a bus 1214. The device also includes one or more input/output (I/O) or peripheral devices 1212. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 1202 may comprise a general-purpose CPU. The CPU 1202 may comprise a single-core or multiple-core CPU. The CPU 1202 may comprise a system-on-a-chip (SoC) or a similar embedded system. In some embodiments, a graphics processing unit (GPU) may be used in place of, or in combination with, a CPU 1202. Memory 1204 may comprise a memory system including a dynamic random-access memory (DRAM), static random-access memory (SRAM), Flash (e.g., NAND Flash), or combinations thereof. In one embodiment, the bus 1214 may comprise a Peripheral Component Interconnect Express (PCIe) bus. In some embodiments, the bus 1214 may comprise multiple busses instead of a single bus.

Memory 1204 illustrates an example of a non-transitory computer storage media for the storage of information such as computer-readable instructions, data structures, program modules, or other data. Memory 1204 can store a basic input/output system (BIOS) in read-only memory (ROM), such as ROM 1208 for controlling the low-level operation of the device. The memory can also store an operating system in random-access memory (RAM) for controlling the operation of the device.

Applications 1210 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 1206 by CPU 1202. CPU 1202 may then read the software or data from RAM 1206, process them, and store them in RAM 1206 again.

The device may optionally communicate with a base station (not shown) or directly with another computing device. One or more network interfaces in peripheral devices 1212 are sometimes referred to as a transceiver, transceiving device, or network interface card (NIC).

An audio interface in peripheral devices 1212 produces and receives audio signals such as the sound of a human voice. For example, an audio interface may be coupled to a speaker and microphone (not shown) to enable telecommunication with others or generate an audio acknowledgment for some action. Displays in peripheral devices 1212 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 1212 may comprise any input device arranged to receive input from a user. An illuminator in peripheral devices 1212 may provide a status indication or provide light. The device can also comprise an input/output interface in peripheral devices 1212 for communication with external devices, using communication technologies, such as USB, infrared, Bluetooth®, or the like. A haptic interface in peripheral devices 1212 provides tactile feedback to a user of the client device.

A GPS receiver in peripheral devices 1212 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a processor, a data log entry associated with a driver of a vehicle, the data log entry including a service provider location and a timestamp;
identifying, by the processor, a vehicle associated the data log entry, wherein identifying the vehicle comprises applying a machine learning model to the data log entry and a vehicle database;
loading, by the processor from a location database, a vehicle location log associated with the identified vehicle, the vehicle location log including a plurality of location data points and associated timestamps;
computing, by the processor, an alternate data log entry based on the data log entry and the vehicle location log, wherein computing the alternate data log entry comprises applying a rule-based optimization algorithm to a historical service provider database; and
transmitting, by the processor to a user device, a recommendation based on the alternate data log entry, wherein the recommendation includes a geospatial visualization of the alternate data log entry.

2. The method of claim 1, wherein identifying the vehicle associated with the driver comprises:
comparing the timestamp of the data log entry with a plurality of predefined driving periods associated with the driver; and
determining, based on the comparison, a driving period that encompasses the timestamp of the data log entry, wherein the driving period is associated with the identified vehicle.

3. The method of claim 1, wherein computing the alternate data log entry comprises:
identifying, based on the vehicle location log, a plurality of alternate service providers within a predefined radius of the service provider location;
filtering the plurality of alternate service providers based on at least one of a fuel type, a vehicle type, or a driver preference; and
selecting an alternate service provider from the filtered plurality of alternate service providers based on a cost optimization algorithm.

4. The method of claim 1, wherein the geospatial visualization of the alternate data log entry is displayed within a dashboard user interface, the dashboard user interface displaying a plurality of service providers and associated data log entries.

5. The method of claim 1, further comprising:
receiving, from a telematics device associated with the identified vehicle, real-time vehicle data including at least one of a fuel level, a location, or a driver behavior metric;
predicting, using a machine learning model, a future transaction based on the real-time vehicle data and the data log entry; and
transmitting, to the user device, a proactive recommendation based on the predicted future transaction.

6. The method of claim 1, wherein transmitting the recommendation to the user device comprises:
generating a message using a neural network, the message including a personalized feedback based on the alternate data log entry; and
transmitting the message to a messaging application installed on the user device.

7. The method of claim 1, further comprising:
identifying, based on the data log entry and the vehicle location log, a driver behavior pattern associated with the driver;
comparing the driver behavior pattern with a plurality of historical driver behavior patterns associated with a plurality of drivers; and
generating, based on the comparison, a driver-specific incentive to modify the driver behavior pattern.

8. A non-transitory computer-readable storage medium for tangibly storing computer program instructions capable of being executed by a processor, the computer program instructions defining steps of:
receiving, by a processor, a data log entry associated with a driver of a vehicle, the data log entry including a service provider location and a timestamp;
identifying, by the processor, a vehicle associated the data log entry, wherein identifying the vehicle comprises applying a machine learning model to the data log entry and a vehicle database;
loading, by the processor from a location database, a vehicle location log associated with the identified vehicle, the vehicle location log including a plurality of location data points and associated timestamps;
computing, by the processor, an alternate data log entry based on the data log entry and the vehicle location log, wherein computing the alternate data log entry comprises applying a rule-based optimization algorithm to a historical service provider database; and
transmitting, by the processor to a user device, a recommendation based on the alternate data log entry, wherein the recommendation includes a geospatial visualization of the alternate data log entry.

9. The non-transitory computer-readable storage medium of claim 8, wherein identifying the vehicle associated with the driver comprises:
comparing the timestamp of the data log entry with a plurality of predefined driving periods associated with the driver; and
determining, based on the comparison, a driving period that encompasses the timestamp of the data log entry, wherein the driving period is associated with the identified vehicle.

10. The non-transitory computer-readable storage medium of claim 8, wherein computing the alternate data log entry comprises:
identifying, based on the vehicle location log, a plurality of alternate service providers within a predefined radius of the service provider location;
filtering the plurality of alternate service providers based on at least one of a fuel type, a vehicle type, or a driver preference; and
selecting an alternate service provider from the filtered plurality of alternate service providers based on a cost optimization algorithm.

11. The non-transitory computer-readable storage medium of claim 8, wherein the geospatial visualization of the alternate data log entry is displayed within a dashboard user interface, the dashboard user interface displaying a plurality of service providers and associated data log entries.

12. The non-transitory computer-readable storage medium of claim 8, the steps further comprising:
receiving, from a telematics device associated with the identified vehicle, real-time vehicle data including at least one of a fuel level, a location, or a driver behavior metric;
predicting, using a machine learning model, a future transaction based on the real-time vehicle data and the data log entry; and
transmitting, to the user device, a proactive recommendation based on the predicted future transaction.

13. The non-transitory computer-readable storage medium of claim 8, wherein transmitting the recommendation to the user device comprises:
generating a message using a neural network, the message including a personalized feedback based on the alternate data log entry; and
transmitting the message to a messaging application installed on the user device.

14. The non-transitory computer-readable storage medium of claim 8, the steps further comprising:
identifying, based on the data log entry and the vehicle location log, a driver behavior pattern associated with the driver;
comparing the driver behavior pattern with a plurality of historical driver behavior patterns associated with a plurality of drivers; and
generating, based on the comparison, a driver-specific incentive to modify the driver behavior pattern.

15. A device comprising:
a processor; and
a storage medium for tangibly storing thereon program logic for execution by the processor, the program logic comprising steps for:
receiving, by the processor, a data log entry associated with a driver of a vehicle, the data log entry including a service provider location and a timestamp;
identifying, by the processor, a vehicle associated the data log entry, wherein identifying the vehicle comprises applying a machine learning model to the data log entry and a vehicle database;
loading, by the processor from a location database, a vehicle location log associated with the identified vehicle, the vehicle location log including a plurality of location data points and associated timestamps;
computing, by the processor, an alternate data log entry based on the data log entry and the vehicle location log, wherein computing the alternate data log entry comprises applying a rule-based optimization algorithm to a historical service provider database; and
transmitting, by the processor to a user device, a recommendation based on the alternate data log entry, wherein the recommendation includes a geospatial visualization of the alternate data log entry.

16. The device of claim 15, wherein identifying the vehicle associated with the driver comprises:
comparing the timestamp of the data log entry with a plurality of predefined driving periods associated with the driver; and
determining, based on the comparison, a driving period that encompasses the timestamp of the data log entry, wherein the driving period is associated with the identified vehicle.

17. The device of claim 15, wherein computing the alternate data log entry comprises:
identifying, based on the vehicle location log, a plurality of alternate service providers within a predefined radius of the service provider location;
filtering the plurality of alternate service providers based on at least one of a fuel type, a vehicle type, or a driver preference; and
selecting an alternate service provider from the filtered plurality of alternate service providers based on a cost optimization algorithm.

18. The device of claim 15, the steps further comprising:
receiving, from a telematics device associated with the identified vehicle, real-time vehicle data including at least one of a fuel level, a location, or a driver behavior metric;
predicting, using a machine learning model, a future transaction based on the real-time vehicle data and the data log entry; and
transmitting, to the user device, a proactive recommendation based on the predicted future transaction.

19. The device of claim 15, wherein transmitting the recommendation to the user device comprises:
generating a message using a neural network, the message including a personalized feedback based on the alternate data log entry; and
transmitting the message to a messaging application installed on the user device.

20. The device of claim 15, wherein the geospatial visualization of the alternate data log entry is displayed within a dashboard user interface, the dashboard user interface displaying a plurality of service providers and associated data log entries.
